(19) United States
(12) Patent Application Publication
(10) Pub. No.: US 2017/0038331 A1
(43) Pub. Date: Feb. 9, 2017

(54) SYSTEM AND METHOD FOR COMPENSATING SAMPLE-RELATED MEASUREMENTS BASED ON POLARIZATION EFFECTS OF TEST STRIPS

(71) Applicant: LifeScan Scotland Limited, Inverness (GB)

(72) Inventors: Gavin MACFIE, Inverness (GB); David MCCOLL, Inverness (GB)

(21) Appl. No.: 14/818,345

(22) Filed: Aug. 5, 2015

(51) Int. Cl. G01N 27/327

(52) U.S. Cl. CPC G01N 27/3274; G01N 27/3272; G01N 27/3273

(57) ABSTRACT

A system and a method for correcting an analyte concentration measurement taken by a test strip is described herein. The test strip includes at least two spaced apart electrodes defining an electrochemical cell or reaction chamber. An initial polarization parameter of the test strip is determined at the time of test strip manufacture and a testing polarization parameter is determined at the time of testing. A resulting correction factor is then determined based on the initial and testing polarization parameters. The correction parameter can be applied to a measured analyte concentration in order to correct the measured analyte concentration.

### TECHNICAL FIELD

This application generally relates to the field of analyte measurement systems and more specifically to portable analyte meters that use test strips configured to determine a concentration of an analyte concentration of a sample. More specifically, the application relates to a system and related method used to correct analyte concentrations based on polarization effects of the test strip.

### BACKGROUND

Analyte concentration determination in physiological fluids (e.g., blood or blood derived products such as plasma) is of ever increasing importance in today's society. Such determinations find use in a variety of applications and settings, including clinical laboratory testing, home testing, etc., where the results of such testing play a prominent role in the diagnosis and management of a variety of disease conditions. Analytes of interest include glucose for diabetes management, cholesterol for monitoring cardiovascular conditions, and the like. In response to this growing importance of analyte detection, a variety of analyte detection protocols and devices for both clinical and home use have been developed. These devices can include electrochemical cells, electrochemical sensors, hemoglobin sensors, antioxidant sensors, biosensors, and immunosensors.

Certain methods for determining analyte concentration in assays are based on electrochemistry. In such methods, an aqueous liquid sample is placed into a sample reaction chamber of a biosensor, such as an analytical test strip having an electrochemical cell made up of at least two electrodes, i.e., a working electrode and a counter electrode. The electrodes of the test strip have an impedance that renders them suitable for amperometric or coulometric measurement. In brief, the sample to be analyzed is allowed to react with a reagent disposed on one electrode to form an oxidizable (or reducible) substance in an amount proportional to the analyte concentration following the application of at least one test potential (voltage). The quantity of the oxidizable (or reducible) substance present is then estimated electrochemically and related to the analyte concentration in the sample.

Because many of these analyte determination systems are portable, and testing may be completed in a short amount of time, patients are able to use such devices in the normal course of their daily lives without significant interruption to their personal routines. As a result, a person with diabetes may measure their blood glucose levels several times a day as a part of a self management process to ensure glycemic control of their blood glucose within a target range. A failure to maintain target glycemic control may result in serious diabetes-related complications including cardiovascular disease, kidney disease, nerve damage and blindness.

Electrochemical glucose test strips, such as those used in the OneTouch®Ultra® whole blood testing kit, which is available from LifeScan, Inc., are designed to measure the concentration of glucose in a physiological fluid sample from patients with diabetes. The measurement of glucose can be based on the selective oxidation of glucose by the enzyme glucose oxidase (GO). The reactions that can occur in a glucose test strip are summarized below in Equations A and B.

Glucose+GO(0)4 Gluconic Acid+GO(red) Eq. A

GO(red)2 Fe(CN)63−G00,0+2 Fe(CN)64− Eq. B

As illustrated in Equation A, glucose is oxidized to gluconic acid by the oxidized form of glucose oxidase (GO₍ₒₓ₎). It should be noted that GO₍ₒₓ₎ may also be referred to as an “oxidized enzyme.” During the reaction in Equation A, the oxidized enzyme GO₍ₒₓ₎ is converted to its reduced state, which is denoted as GO_{(red)} (i.e, “reduced enzyme”). Next, the reduced enzyme GO_{(red)} is re-oxidized back to GO₍ₒₓ₎ by reaction is with Fe(CN)₆³⁻ (referred to as either the oxidized mediator or ferricyanide) as illustrated in Equation B. During the re-generation of GO_{(red)} back to its oxidized state GO₍ₒₓ₎, Fe(CN)₆³⁻ is reduced to Fe(CN)₆⁴⁻ (referred to as either reduced mediator or ferrocyanide).

When the reactions set forth above are conducted with a test signal applied between two electrodes, a test current can be created by the electrochemical re-oxidation of the reduced mediator at the electrode surface. Thus, since, in an ideal environment, the amount of ferrocyanide created during the chemical reaction described above is directly proportional to the amount of glucose in the sample positioned between the electrodes, the test current generated would be proportional to the glucose content of the sample. A mediator, such as ferricyanide, is a compound that accepts electrons from an enzyme such as glucose oxidase and then donates the electrons to an electrode. As the concentration of glucose in the sample increases, the amount of reduced mediator formed also increases; hence, there is a direct relationship between the test current, resulting from the re-oxidation of reduced mediator, and glucose concentration. In particular, the transfer of electrons across the electrical interface results in the flow of a test current (2 moles of electrons for every mole of glucose that is oxidized). The test current resulting from the introduction of glucose can, therefore, be referred to as a glucose signal.

Electrochemical biosensors, such as those described above, among others, may be adversely affected by physical changes that occur to test strip electrodes. In particular, the electrodes may be subject to depolarization effects which occurs over time, particularly with regard to electrodes deposited as a result of carbon screening. The foregoing effect may create a time-based degradation in the performance of the electrodes and therefore, the reliability of the associated test strip and the accuracy of any resulting analyte concentration measurements.

Several strategies have been used to reduce or avoid the effects of these physical changes to electrodes. For example, it has been found that depolarization of the electrodes will stabilize after a period of time; typically, several months. Therefore and according to one technique the test strips are manufactured but not used until sometime after the typical stabilization period. This technique increases the cost of the test strip due to costs of storage and the delay in selling the test strips. In addition, if the wait time is calculated incorrectly and the test strips are sold before the electrodes stabilize, the inaccurate test strips can negatively affect the health of users relying on the test strips.

### BRIEF DESCRIPTION OF THE INVENTION

Various embodiments of a test meter and a method for improving the accuracy of an analyte test strip are describe herein. Advantageously, test strips can be calibrated in order to corrects for physical changes, such as depolarization of the electrodes of the test strip in order to provide greater accuracy in resulting analyte concentration measurements.

According to a first aspect, a method for determining an analyte concentration of a sample fluid applied to a test strip is described herein. The test strip includes at least two electrodes in spaced relation and defining a reaction chamber. In this aspect, the method includes determining an initial polarization parameter of the test strip at the time of test strip manufacture and determining a testing polarization parameter of the test strip at the time of testing. The method further includes determining a correction parameter of the test strip based on the initial polarization parameter and the testing polarization parameter. An initial analyte concentration is measured and the correction parameter is applied to the initial analyte concentration to produce a corrected analyte concentration.

The at least two electrodes can include carbon screened electrodes to which an electrical potential can be applied in order to measure an analyte concentration. Measuring the initial analyte concentration includes applying an electrical test potential to one of the at least two electrodes, measuring a resulting current output in response to the applied electrical test potential, and determining the initial analyte concentration based on the current output. The polarization parameter is determined by applying a first potential between the at least two electrodes; measuring a resulting first current I₁ at the first potential; applying a second potential between the at least two electrodes; measuring a second resulting current I₂ at the second potential; and determining the polarization parameter as a ratio between the first current I₁ and the second current I₂. The polarization parameter is calculated as

$$P P = \frac{{I}_{1}}{{I}_{2}} ,$$

wherein PP=polarization parameter, I₁=current measured at the first potential, and I₂=current measured at the second potential. The first potential can be lower than the second potential. The correction parameter is based on a ratio of the initial polarization parameter and the testing polarization parameter. The correction parameter is calculated as

$$Corr = \frac{P {P}_{i}}{P {P}_{t}} ,$$

wherein Corr=Correction parameter, PPᵢ=initial polarization parameter, and PPₜ=testing polarization parameter. The corrected analyte measurement is calculated as

$${A}_{C} = \frac{{A}_{M}}{Corr} ,$$

wherein A_{C}=corrected analyte measurement, A_{M}=analyte measurement, and Corr=correction parameter. The method can further include applying the correction parameter to the initial analyte measurement only when the analyte concentration exceeds a predetermined threshold. The predetermined threshold can be 200 mg/dL. In another example, the predetermined threshold can be 300 mg/dL. The step of determining a testing polarization parameter can be performed during analyte measurement. The sample fluid can be blood and the analyte can be glucose.

According to another aspect, a method for calibrating a test strip is described herein. The test strip includes at least two electrodes spaced apart as part of a reaction chamber. The method can include determining an initial polarization parameter of the test strip at the time of test strip manufacture and determining a testing polarization parameter of the test strip at the time of testing. The method can additionally include determining a correction parameter based on the initial polarization parameter and the testing polarization parameter. The correction parameter can be a ratio between the initial polarization parameter and the testing polarization parameter and the correction parameter is determined in order to calibrate the test strip.

The at least two electrodes can include carbon screened electrodes to which an electrical potential can be applied in order to measure an analyte concentration. The electrodes can be applied by a carbon screening process. The polarization parameter is determined by applying a first potential between the at least two electrodes; measuring a resulting first current I₁ at the first potential; applying a second potential between the at least two electrodes; measuring a second resulting current I₂ at the second potential; and determining the polarization parameter as a ratio between the first current I₁ and the second current I₂. The polarization parameter is calculated as

$$P P = \frac{{I}_{1}}{{I}_{2}} ,$$

wherein

PP=polarization parameter, I₁=current measured at the first potential, and I₂=current measured at the second potential. The first potential can be lower than the second potential. The correction parameter is based on a ratio of the initial polarization parameter and the testing polarization parameter. The correction parameter is calculated as

$$Corr = \frac{{PP}_{i}}{{PP}_{t}} ,$$

wherein Corr=Correction parameter, PPᵢ=initial polarization parameter, and PPₜ=testing polarization parameter. The method can further include applying the correction parameter to a measured analyte concentration to determine a corrected glucose measurement. The measured analyte concentration can be measured by applying an electrical test potential to the at least two electrodes, measuring a resulting current output of the at least two electrodes in response to the applied electrical test potential, and determining the measured analyte concentration based on the current output.

According to yet another aspect, an analyte measurement system is described herein. The analyte measurement system includes a test strip and a test meter. The test strip includes at least two spaced apart electrodes defining a reaction chamber. The at least two electrodes can be carbon electrodes to which an electrical potential can be applied in order to measure an analyte concentration. The test meter includes a strip port with connectors configured to couple to the at least two electrodes of the test strip and a processor. The processor is configured to determine a testing polarization parameter of the test strip at a time of testing. The processor accesses a stored initial polarization parameter of the test strip. The initial polarization parameter was determined at a time of test strip manufacture. The processor determines a correction parameter of the test strip based on the initial polarization parameter and the testing polarization parameter. The processor measures an analyte concentration and applies the correction parameter to the measured analyte concentration to produce a corrected analyte concentration.

The electrodes can be formed using a carbon screen printing process. Measuring the initial analyte concentration can include applying an electrical test potential to one of the at least two electrodes, measuring a resulting current output in response to the applied electrical test potential, and determining the initial analyte concentration based on the current output. The polarization parameter is determined by applying a first potential between the at least two electrodes; measuring a resulting first current I₁ at the first potential; applying a second potential between the at least two electrodes; measuring a second resulting current I₂ at the second potential; and determining the polarization parameter as a ratio between the first current I₁ and the second current I₂. The polarization parameter is calculated as

$$PP = \frac{{I}_{1}}{{I}_{2}} ,$$

wherein PP=polarization parameter, I₁=current measured at the first potential, and I₂=current measured at the second potential. The first potential can be lower than the second potential. The correction parameter is based on a ratio of the initial polarization parameter and the testing polarization parameter. The correction parameter is calculated as

$$Corr = \frac{{PP}_{i}}{{PP}_{t}} ,$$

wherein Corr=Correction parameter, PPᵢ=initial polarization parameter, and PPₜ=testing polarization parameter. The corrected analyte measurement is calculated as

$${A}_{C} = \frac{{A}_{M}}{Corr} ,$$

wherein A_{C}=corrected analyte measurement, A_{M}=analyte measurement, and Corr=correction parameter. The method can further include applying the correction parameter to the initial analyte measurement only when the analyte concentration exceeds a predetermined threshold. The predetermined threshold can be 200 mg/dL. In another example, the predetermined threshold can be 300 mg/dL. The step of determining a testing polarization parameter can be performed during analyte measurement. The sample fluid can be blood and the analyte can be glucose.

These and other features and advantages will become apparent to those skilled in the art when taken with reference to the following more detailed description of the exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1 illustrates an exemplary analyte measurement system that includes a test meter and an analyte test strip;

FIG. 2 illustrates in simplified schematic form the components of a test meter used in an exemplary analyte measurement system;

FIG. 3 illustrates an exploded assembly view of an exemplary test strip of an analyte measurement system;

FIG. 4A illustrates an exemplary waveform used by an analyte measurement device, including a test potential applied to a test strip over a predetermined time interval for purposes of obtaining an analyte concentration measurement;

FIG. 4B illustrates a graph of time over output current in response to the test potential of FIG. 4A;

FIG. 5 illustrates comparative analyte measurements taken of exemplary batches of test strips;

FIG. 6 illustrates polarization curves comparatively obtained of the exemplary test strip batches of FIG. 5;

FIG. 7 illustrates a comparison of normalized polarization curves of the exemplary test strip batches of FIGS. 5 and 6;

FIG. 8 illustrates a comparative representation of polarization parameter curves of the exemplary test strip batches of FIGS. 5-7;.

FIG. 9 illustrates comparative analyte measurement curves of the exemplary test strip batches of FIGS. 5-8 taken at discrete test potentials;

FIG. 10 illustrates the application of determined correction factors, shown graphically in regard to the exemplary test strip batches of FIGS. 5-9;

FIG. 11 illustrates a comparison of corrected analyte measurements to uncorrected analyte measurements of the exemplary test strip batches of FIGS. 5-10;

FIG. 12 illustrates a bias comparison of corrected analyte measurements to uncorrected analyte measurements of the exemplary test strip batches of FIGS. 5-11;

FIG. 13 illustrates a flow chart of an exemplary method for correcting the analyte concentration results obtained by a test strip based on changes in polarization; and

FIG. 14 illustrates a flow chart of another exemplary method for correcting the analyte concentration results obtained by a test strip based on changes in polarization.

### DETAILED DESCRIPTION

The following detailed description should be read with reference to the drawings, in which like elements in different drawings are identically numbered for the sake of clarity. The drawings, which are not necessarily to scale, are intended to depict selected embodiments and are not intended to limit the intended scope of the invention, except where so expressly indicated. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “patient” or “user” refer to any human or animal subject and are not intended to limit the systems or methods to human use, although use of the subject invention in a human patient represents a preferred embodiment.

The term “sample” means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein include blood, plasma, red blood cells, serum and suspensions thereof.

The terms “about” and “substantially” are used in connection with a numerical value throughout the description and claims denotes an interval of accuracy, familiar and acceptable to a person skilled in the art. The interval governing this term is preferably ±20%. Unless specified, the terms described above are not intended to narrow the scope of the invention as described herein and according to the claims.

Certain exemplary embodiments will now be described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

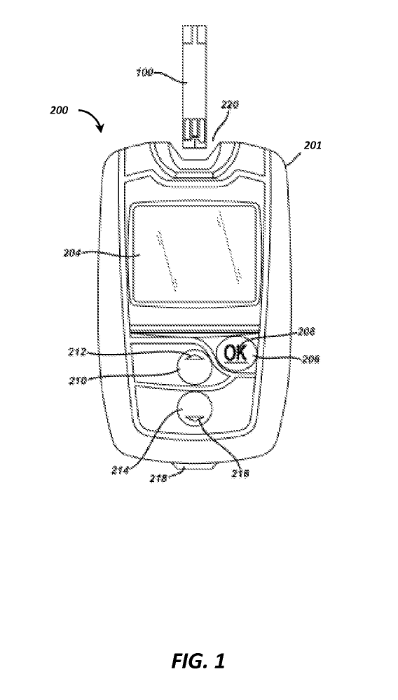

FIG. 1 illustrates an exemplary analyte measurement system in which an exemplary test meter 200 is employed for testing analyte (e.g., glucose) levels in the blood of an individual using a test strip 100, as illustrated and described herein. As will be further described with regard to the following figures, the test meter 200 is configured to calibrate the test strip 100 in order to compensate for changes in a physical property (polarization of the electrodes) in the test strip 100 over time. The test meter 200 according to the depicted embodiment includes a housing 201 having an array of user interface inputs (206, 210, 214), which can be in the form of buttons, for purposes of entry of data, navigation of menus, and execution of commands disposed on the exterior of the housing 201. Data can include values representative of analyte concentration, and/or information that are related to the everyday lifestyle of an individual. Information, which is related to a user's everyday lifestyle, can include food intake, medication use, the occurrence of health check-ups, general health condition, and exercise levels of an individual. The test meter 200 can also include a resident display 204 that can be used to report measured glucose levels, and to facilitate entry of lifestyle related information.

More specifically and as shown in FIG. 1, the exemplary test meter 200 may include a first user interface input 206, a second user interface input 210, and a third user interface input 214 in the form of depressible buttons. Alternatively, the inputs could be provided as part of a touch screen, either as part of the display, or separate therefrom. Each of the user interface inputs 206, 210, and 214 facilitate entry and analysis of data stored by the test meter 200, enabling a user to navigate through the user interface displayed on display 204. The user interface inputs 206, 210, and 214 include a first marking 208, a second marking 212, and a third marking 216, which help in correlating user interface inputs to characters provided on display 204, such as to facilitate navigation.

The test meter 200 can be turned on, such as a sleep mode, by inserting a test strip 100 into a strip port connector 220 provided by the meter housing 201. Alternatively, the meter 200 can be activated by pressing and briefly holding the first user interface input 206, or by the detection of data traffic across a data port 218. The test meter 200 can be switched off by removing the test strip 100, pressing and briefly holding the first user interface input 206, navigating to and selecting a meter off option from a main menu screen, and/or by not pressing any buttons for a predetermined time. The display 104 can optionally include a backlight.

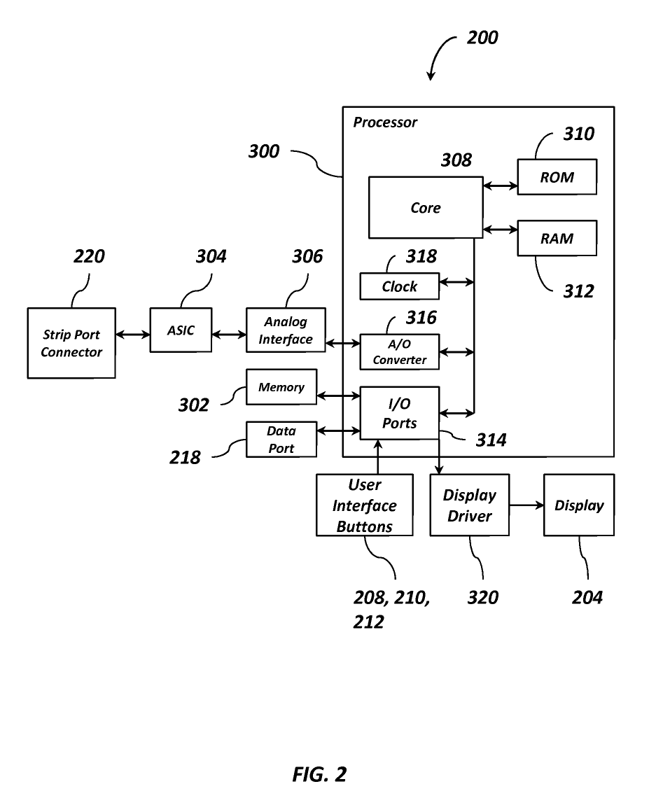

Referring to FIG. 2, an exemplary internal layout of the test meter 200 is shown. The test meter 200 may include a processor 300, which in some embodiments described and illustrated herein, is a 32-bit RISC microcontroller. In the embodiments described and illustrated herein, the processor 300 is selected from the MSP 430 family of ultra-low power microcontrollers manufactured by Texas Instruments of Dallas, Tex. As will be further described below, the processor 300 is configured to calibrate the test strip 100. The processor 300 can be bi-directionally connected via I/O ports 314 to a memory 302, which in some embodiments described and illustrated herein is an EEPROM. Also connected to the processor 300 via I/O ports 314 are the data port 218, the user interface inputs 208, 210, and 212, and a display driver 320. The data port 218 can be connected to the processor 300, thereby enabling transfer of data between the memory 302 and an external device, such as a personal computer (not shown). According to this version, the user interface inputs 208, 210, and 212 are directly connected to the processor 300. The processor 300 controls the display 204 via a display driver 320. The memory 302 may be pre-loaded with calibration information, such as a test strip initial polarization parameter, discussed in greater detail herein, during production of the test meter 200. Alternatively, calibration information can be loaded to the memory 302 as a field update. This calibration information can be accessed and used by the processor 300 upon receiving a suitable signal (such as current) from the test strip 100 via the strip port connector 220 so as to calculate a corresponding analyte level, such as blood glucose concentration, using the signal and the calibration information without receiving calibration input from any external source. Alternatively, the processor 300 may access an external device (not shown) in order to access the calibration information.

In embodiments described and illustrated herein, the test meter 200 may include an Application Specific Integrated Circuit (ASIC) 304, so as to provide electronic circuitry used in measurements of analyte levels in a sample that has been applied to a test strip 100 inserted into the strip port connector 220. Analog voltages can pass to and from the ASIC 304 by way of an analog interface 306. Analog signals from the analog interface 306 can be converted to digital signals by an A/D converter 316. The processor 300 further includes a core 308, a ROM 310 (containing computer code), a RAM 312, and a clock 318. In one embodiment, the processor 300 is configured (or programmed) to disable all of the user interface inputs except for a single input upon a display of an analyte value by the display 204 such as, for example, during a time period after an analyte measurement. In an alternative embodiment, the processor 300 is configured (or programmed) to ignore any input from all of the user interface inputs except for a single input upon a display of an analyte value by the display unit. Detailed descriptions and illustrations of the exemplary test meter 200 are shown and described in International Patent Application Publication No. W02006070200, which is hereby incorporated by reference into this application as if fully set forth herein.

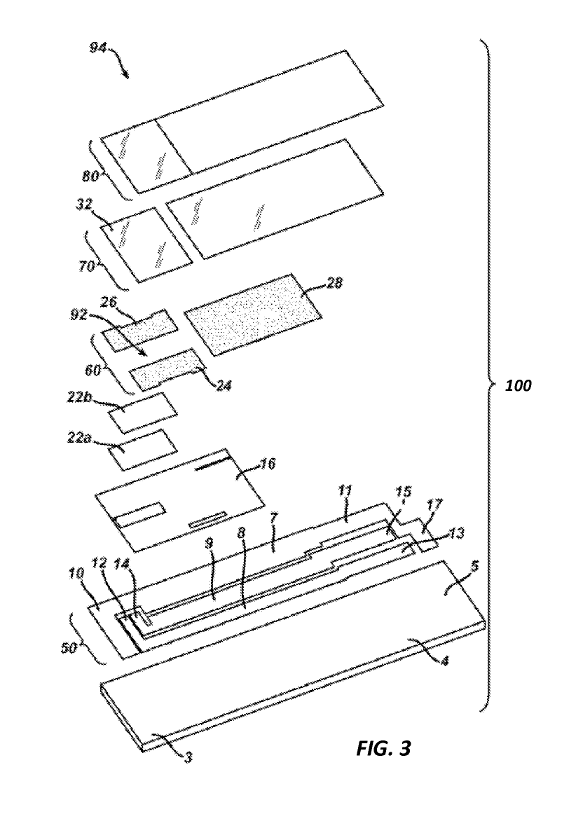

FIG. 3 is an exemplary exploded perspective view of a test strip 100, which may include a plurality of layers that are disposed upon one side of a planar substrate 5 which forms a lower portion of the test strip 100. In brief and according to this exemplary embodiment, these layers include a first conductive layer 50 (which can also be referred to as electrode layer 50), an insulation layer 16, two overlapping reagent layers 22a and 22b, an adhesive layer 60, which includes adhesive portions 24, 26, and 28, a hydrophilic tape layer 70, and a top or upper layer 80 which forms a cover 94 for the test strip 100. The test strip 100 may be manufactured according to a series of steps in which the conductive layer 50, insulation layer 16, reagent layers 22a, 22b, and adhesive layer 60 are sequentially deposited onto the substrate 5 using, for example, a screen-printing process. For purposes of the following description, the exemplary test strip 100 includes three (3) electrodes 10, 12, and 14. However, it should be noted that this parameter can be varied depending on the application. For example and according to another version, the test strip can include at least two (2) electrodes while in another embodiment (not shown) the test strip 100 can include five (5) electrodes. The hydrophilic layer 70 and top layer 80 can be disposed from a roll stock and laminated onto the planar substrate 5 as either an integrated laminate or as separate layers. In terms of orientation throughout, the test strip 100 is defined by a distal portion 3 and an opposite proximal portion 4 as shown in FIG. 3. As used herein and for description purposes, the term “proximal” indicates that a reference structure is closer in relation to the test meter 200 and the term “distal” indicates that a reference structure is further away from the test meter 200.

The test strip 100 may include a sample-receiving chamber 92 through which a physiological fluid sample may be drawn through or deposited. The physiological fluid sample discussed herein may be blood, typically obtained from the finger of a patient. The sample-receiving chamber 92 can include an inlet at a proximal end and an outlet at the side edges of the test strip 100, as illustrated in FIG. 3. A fluid sample can be applied to the inlet to fill the sample-receiving chamber 92 so that analyte levels can be measured. The side edges of a first adhesive pad 24 and a second adhesive pad 26 located adjacent to the reagent layer 22a, 22b each define a wall of the sample-receiving chamber 92, as illustrated in FIG. 3. A bottom portion or “floor” of the sample-receiving chamber 92 may include a portion of the substrate 5, conductive layer 50, and insulation layer 16, as illustrated in FIG. 3. A top portion or “roof’of sample-receiving chamber 92 may include the distal hydrophilic portion 32, as illustrated in FIG. 3. For the test strip 100, as illustrated in FIG. 3, the substrate 5 can be used as a foundation for helping support subsequently applied layers. The substrate 5 can be in the form of a polyester sheet such as a polyethylene tetraphthalate (PET) material (e.g., Hostaphan PET supplied by Mitsubishi). The substrate 5 can be in a roll format, nominally 350 microns thick by 370 millimeters wide and approximately 60 meters in length.

A conductive layer is required for forming electrodes that can be used for the electrochemical measurement of the analyte. In an embodiment, a first conductive layer 50 can be made from a carbon ink that is screen-printed onto the substrate 5. In this embodiment and using a screen-printing process, the carbon ink is loaded onto a screen and then transferred through the screen using a squeegee (not shown). The printed carbon ink can be dried using hot air at about 140° C. The carbon ink can include VAGH resin, carbon black, graphite (KS15), and one or more solvents for the resin, carbon, and graphite mixture. More particularly, the carbon ink may incorporate a ratio of carbon black: VAGH resin of about 2.90:1 and a ratio of graphite: carbon black of about 2.62:1 in the carbon ink.

For the test strip 100, as illustrated in FIG. 3, the first conductive layer 50 may include a reference electrode 10, a first working electrode 12, and a second working electrode 14. During use of the test strip 100 to determine an analyte concentration in a bodily fluid sample, such as blood glucose concentration in a whole physiological fluid sample, the electrodes 10, 12, and 14 are employed by the test meter 200 to monitor an electrochemical response of the test strip 100. In another embodiment, the test strip 100 can be configured with additional third and fourth physical characteristic sensing electrodes (not shown). The latter test strips including additional physical characteristic sensing electrodes are described in greater detail in International Patent Application No. PCT/GB2012/053276, entitled “Accurate Analyte Measurements for Electrochemical Test Strip Based on Sensed Physical Characteristic(s) of the Sample Containing the Analyte”, published as International Patent Application Publication No. WO 2013/098563, the entirety of which is herein incorporated by reference. According to this embodiment, the first conductive layer 50 can also include a first contact pad 13, a second contact pad 15, a reference contact pad 11 at the proximal portion of the test strip 100 in which a first working electrode track 8, a second working electrode track 9 and a reference electrode track 7 interconnect with the working electrodes 12, 14 and reference electrode 10, respectively. A strip detection bar 17 is further provided. The conductive layer 50 may be formed from carbon ink. The first contact pad 13, second contact pad 15, and reference contact pad 11 may be adapted to electrically connect to a test meter, such as test meter 200. The first working electrode track 8 provides an electrically continuous pathway from the first working electrode 12 to the first contact pad 13. Similarly, the second working electrode track 9 provides an electrically continuous pathway from the second working electrode 14 to the second contact pad 15 and the reference electrode track 7 provides an electrically continuous pathway from the reference electrode 10 to the reference contact pad 11. The strip detection bar 17 is electrically connected to the reference contact pad 11. A test meter, such as test meter 200, can detect that the test strip 100 has been properly inserted by measuring a continuity between the reference contact pad 11 and the strip detection bar 17, as illustrated in FIG. 3.

Conventional electrochemical-based analyte test strips employ a working electrode along with an associated counter/reference electrode and enzymatic reagent layer to facilitate an electrochemical reaction with an analyte of interest and, thereby, determine the presence and/or concentration of that analyte. For example, an electrochemical-based analyte test strip for the determination of glucose concentration in a fluid sample can employ an enzymatic reagent that includes the enzyme glucose oxidase and the mediator ferricyanide (which is reduced to the mediator ferrocyanide during the electrochemical reaction). Such conventional analyte test strips and enzymatic reagent layers are described in, for example, U.S. Pat. Nos. 5,708,247; 5,951,836; 6,241,862; and 6,284,125; each of which is hereby incorporated by reference herein to this application. In this regard, the reagent layer employed in various embodiments provided herein can include any suitable sample-soluble enzymatic reagents, with the selection of enzymatic reagents being dependent on the analyte to be determined and the bodily fluid sample. For example, if glucose is to be determined in a fluid sample, the enzymatic reagent layer can include glucose oxidase or glucose dehydrogenase along with other components necessary for functional operation.

In general, an enzymatic reagent layer includes at least an enzyme and a mediator. Examples of suitable mediators include, for example, ruthenium, Hexaammine Ruthenium (III) Chloride, ferricyanide, ferrocene, ferrocene derivatives, osmium bipyridyl complexes, and quinone derivatives. Examples of suitable enzymes include glucose oxidase, glucose dehydrogenase (GDH) using a pyrroloquinoline quinone (PQQ) co-factor, GDH using a nicotinamide adenine dinucleotide (NAD) co-factor, and GDH using a flavin adenine dinucleotide (FAD) co-factor. An enzymatic reagent layer can be applied during manufacturing using any suitable technique including, for example, screen printing. The enzymatic reagent layer may also contain suitable buffers (such as, for example, Tris HCl, Citraconate, Citrate and Phosphate), hydroxyethylcelulose [HEC], carboxymethylcellulose, ethycellulose and alginate, enzyme stabilizers and other additives as are known in the field.

In use, physiological fluid or a control solution may be delivered to the sample receiving chamber 92 for electrochemical analysis. The sample receiving chamber 92 of the test strip 100 may have a small volume. For example, the volume may range from about 0.1 microliters to about 5 microliters, preferably about 0.2 microliters to about 3 microliters, and more preferably about 0.3 microliters to about 1 microliter. As will be appreciated by those skilled in the art, the sample receiving chamber 92 may be suitably configured and sized to enable other volumes. To provide the small sample volume, the sample receiving chamber 92 may have an area ranging from about 0.01 cm² to about 0.2 cm², preferably about 0.02 cm² to about 0.15 cm², and more preferably about 0.03 cm² to about 0.08 cm². Similarly, those skilled in the art will appreciate that the volume sample receiving chamber 92 may be appropriately sized. In addition, the first working electrode and second working electrode 12, 14 may be spaced in the range of about 1 micron to about 500 microns, preferably in the range of about 10 microns to about 400 microns, and more preferably in the range of about 40 microns to about 200 microns. In other embodiments, such a range may vary between various other values. According to this exemplary embodiment, the spacing between the electrodes 12, 14 allows reduction/oxidation cycling to occur, where an oxidized mediator generated at the first working electrode 12, diffuses to the second working electrode 14 to become reduced, and subsequently diffuses back to the first working electrode 12 to become oxidized again under the application of at least one test potential.

Further details regarding the use of electrodes and enzymatic reagent layers for the determination of the concentrations of analytes in a bodily fluid sample, are in U.S. Pat. No. 6,733,655, which is hereby fully incorporated by reference herein to this application.

A quantity of the fluid sample of interest may be introduced into the test strip 100, and more specifically the electrochemical cell (reaction chamber) that includes the reference electrode 10, the first working electrode 12, the second working electrode 114, and a reagent layer. The fluid sample may be whole blood or a derivative or fraction thereof, or a control solution. The fluid sample, e.g., blood, may be dosed into the sample receiving chamber 92 via the inlet. In one aspect, the inlet and/or the sample receiving chamber 92 may be configured such that capillary action causes the fluid sample to fill the sample receiving chamber 92.

Additional details regarding the features of the exemplary test strip 100 can be found in pending International Patent Application No. PCT/US2010/062629, entitled “Systems and Methods for High Accuracy Analyte Measurement”, published as International Patent Application Publication No. WO 2012/091728, the entirety of which is herein incorporated by reference.

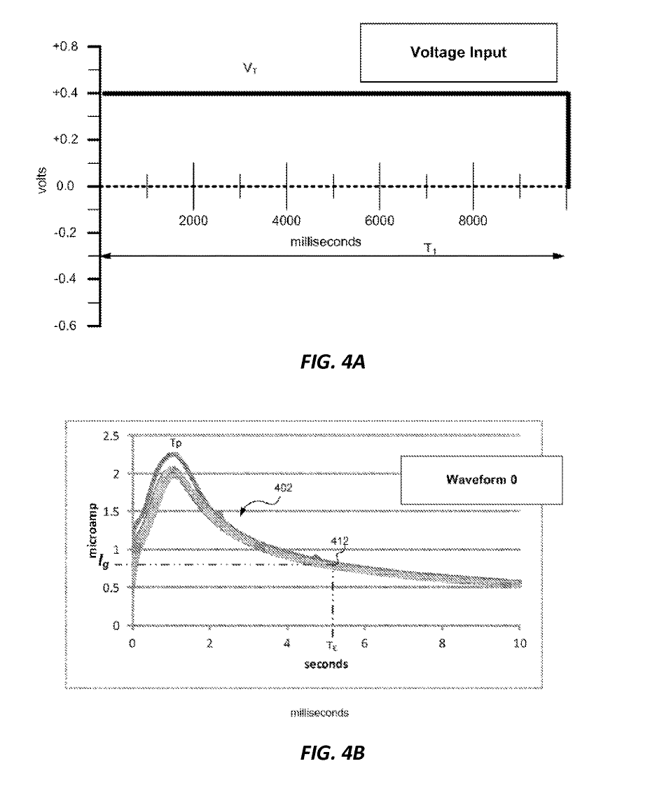

Upon insertion of the test strip 100 in the test meter 200, the analyte concentration of the sample can be determined from current output transients (i.e., measured electrical current response in microamperes as a function of time) that are measured when the test voltages of FIG. 4A are applied to the test strip 100.

In FIG. 4A, the test voltage applied to the test strip 100 is generally from about +100 millivolts to about +600 millivolts. In one embodiment in which the electrodes include carbon ink, the mediator is ferricyanide, and the analyte in question is glucose, the test voltage applied to the test strip 100 is about +400 millivolts. Other analytes, mediator, and electrode material combinations will require different test voltages. The duration of the test voltage 402 is generally from about 2 to about 4 seconds after a reaction period and is typically about 3 seconds after a reaction period. Typically, time T₁ is measured relative to a time point when the sample is detected on the electrodes 10, 12, 14. As the voltage V_{T1} is maintained in FIG. 4A for the duration of T₁, the current transient 402 for the first working electrode is generated starting at zero time (and likewise the current transient for additional electrodes can also be generated with respect to the zero time), as shown in FIG. 4B. The current transient 402 builds up to a maximum proximate peak time Tₚ at which time the current slowly drops off until approximately 5 seconds after zero time. At the point 406, the current value “I_{g}” 412 for a working electrode 12, 14 is measured at time T_{E}. Because the test strip 100 includes more than one working electrode 12, 14, a plurality of current transients besides current transient 402 can be provided by the test strip 100. Where there is more than one working electrodes 12, 14, the current outputs I_{g} at sampling time T_{E} is added together to derive the output current that can be used to determine glucose concentration. It is noted that in one embodiment, the time T_{E} is selected to be a single time point (or a range of time points) at a certain interval from a peak current output at time Tₚ. Alternatively, the time T_{E} may be a fixed time point from the start time 0 of the test sequence. In yet another alternative, the time T_{E} can be a time point selected from a table correlated to at least one physical characteristic of the sample.

From knowledge of the calibration code offset and slope for the particular biosensor 100, the analyte concentration can be calculated. “Intercept” and “Slope” are the values obtained by measuring calibration data from a batch of test strips. Additional details, including algorithms used for determining analyte concentration can be found in pending International Patent Application No. PCT/US2010/062629, entitled “Systems and Methods for High Accuracy Analyte Measurement”, published as International Patent Application Publication No. WO 2012/091728, and pending U.S. Patent Application Publication No. 2014/0027312, entitled “Systems and Methods to Account for Interferents in a Glucose Biosensor”, the entirety of each of which is herein incorporated by reference.

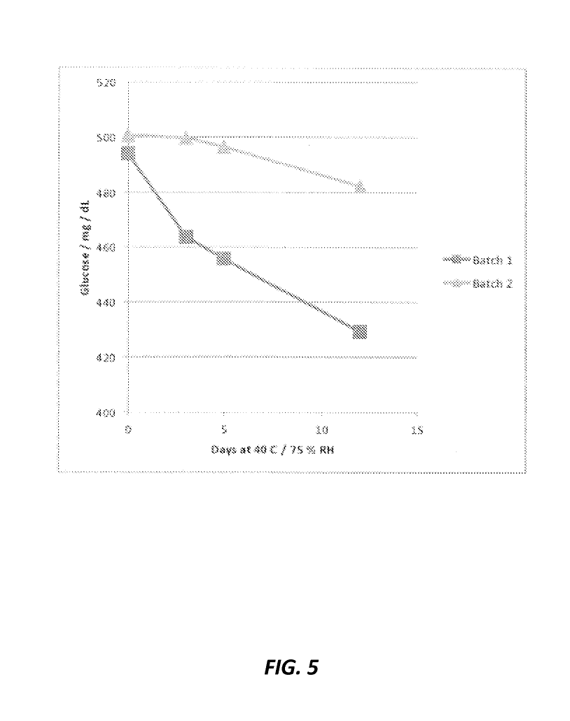

It has been determined that performance of the electrodes 10, 12, 14, of the exemplary test strip 100 can decrease over time. In particular, over time the electrodes 10, 12, 14, can experience a decrease in polarization over time due to the carbon screening process. In particular, carbon screened electrodes suffer depolarization over a period of time after manufacture of the electrodes until the electrodes stabilize, typically several months after manufacture. This decrease in polarization negatively affects the performance of the test strip 100, resulting in inaccurate analyte measurement results. This change in analyte measurement results due to electrode depolarization is graphically illustrated by FIG. 5, which comparatively illustrates the change in analyte (i.e., glucose) response for two separate batches of test strips over time. In this example, two batches of test strips, Batch 1 and Batch 2 were analyzed. For purposes of this example, Batch 1 and Batch 2 were manufactured using different grades of carbon ink. Batch 1 and Batch 2 were aged to an equivalent of two (2) months at ambient temperatures using aggressive storage conditions in order to emulate typical storage conditions that would be experienced over the shelf-life of the test strips. As noted in FIG. 5 and under the noted conditions, the measured glucose concentrations show a trended decrease over time, in which the overall amount of decrease is batch (strip) dependent. The glucose concentration was 500 mg/dL. However, as illustrated by FIG. 5, over time, the glucose measurement of Batch 1, which had the lower starting polarization, dropped by around 75 mg/dL while the glucose measurement of Batch 2 dropped by less than 20 mg/dL.

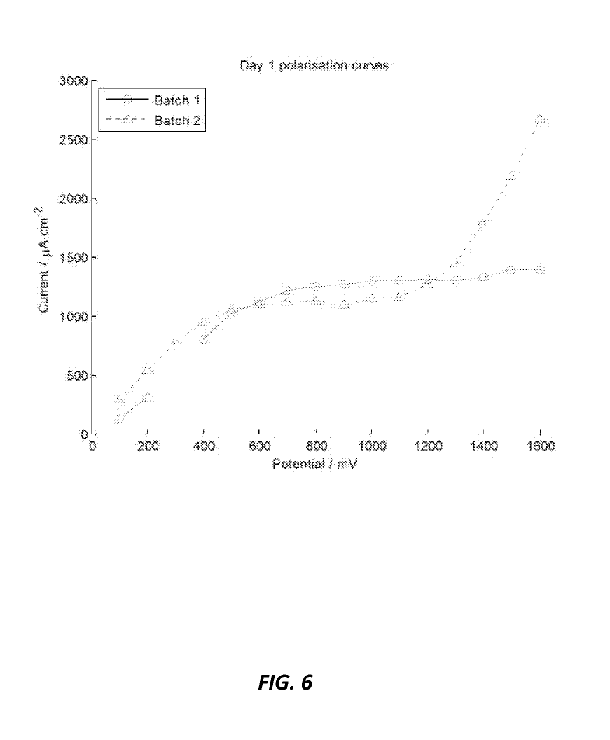

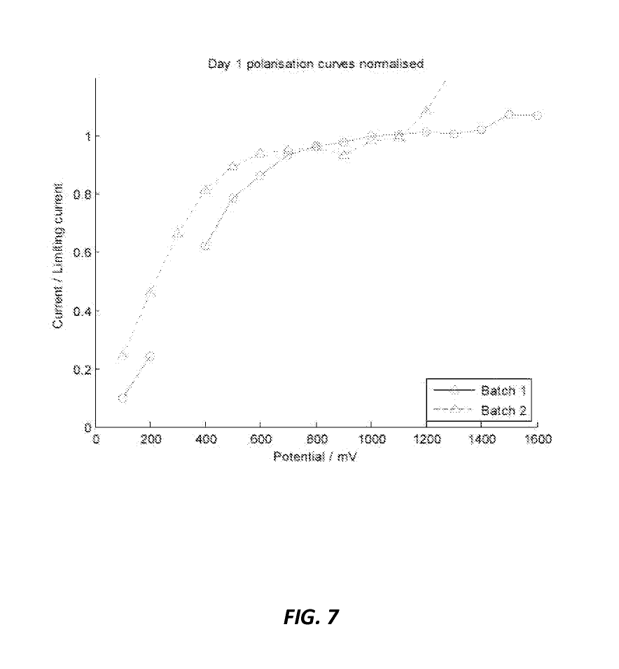

As illustrated by FIG. 6, which illustrates a polarization curve for batches 1 and 2, and FIG. 7, which illustrates a normalized polarization curve for batches 1 and 2, Batches 1 and 2 show contrasting polarization behavior. Specifically, Batch 2 is more completely polarized than Batch 1, reaching its diffusion limited plateau at 600 mV rather than 800 mV in the case of Batch 2. It is noted the contrasting polarization is particularly evident at the measurement potential of 400 mV where the effective polarization, as inferred from current/limiting current, is 0.6 for Batch 1 and 0.85 for Batch 2. The polarization behavior is determined by filling the test strips of each batch with a solution containing 200 mM of potassium ferricyanide and 20 mM of potassium ferrocyanide. After filling the test strips, a potential is applied to the test strips and the current output after the potential is applied is then recorded. For purposes of this example, the current was measured five (5) seconds after the potential was applied and the polarization data was normalized by dividing by the diffusion limited current, which is the average of the currents measured at potentials between 900 and 1200 mV.

As noted above and further discussed below, a test meter can be configured to compensate for decreases in polarization and calculate a correction factor in order to calibrate the test strip and produce more accurate analyte measurements.

In order to calculate a correction factor, a polarization parameter of the test strip 100 is determined at the time the test strip is manufactured by calculating an initial polarization parameter. Subsequently, a testing polarization parameter is calculated at the time the test strip is put to use for testing. In an embodiment, the testing polarization parameter can be determined before or after measurement of the analyte concentration. In another embodiment, the testing polarization parameter can be determined concurrently with measurement of the analyte concentration.

In order to determine the polarization parameter, a first potential is applied between the working electrodes 12, 14 of the test strip 100, thereby generating a first current I₁. Alternatively, the potential can be applied between a working electrode 12, 14 and the counter electrode 10 or between both working electrodes 12, 14, and the counter electrode 10. After measuring the first current I₁, a second potential, which is greater in magnitude than the first potential, is applied between the electrodes 12, 14 of the test strip 100. The second current I₂, which results from this second potential, is measured wherein the polarization parameter is determined as a ratio between the first current I₁ and the second current I₂. This ratio is calculated as shown below by Equation 1:

$$PP = \frac{{I}_{1}}{{I}_{2}} , \qquad ( Equation 1 )$$

wherein PP=polarization parameter, I₁=the first current measured at the first potential, and I₂=the second current measured at the second potential. Because the polarization parameters are calculated as a ratio of currents, the polarization parameter is dimensionless and therefore independent of all factors affecting the current values, such as the electrode area, concentration of redox species, and the diffusion coefficient.

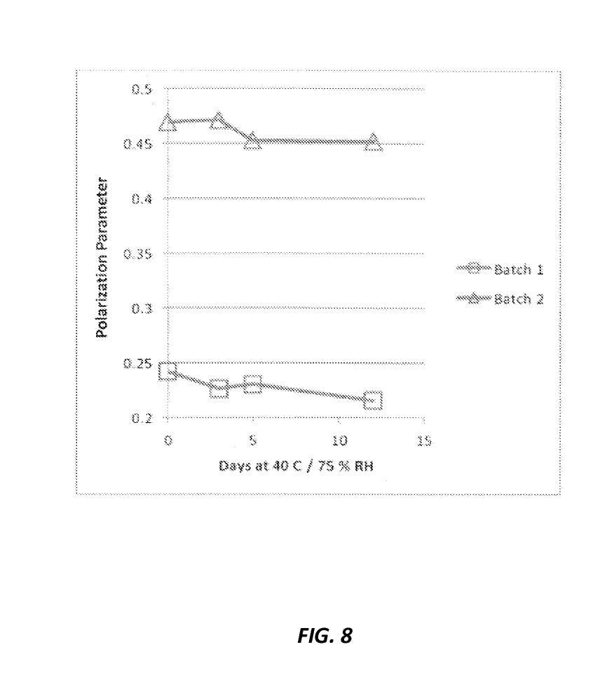

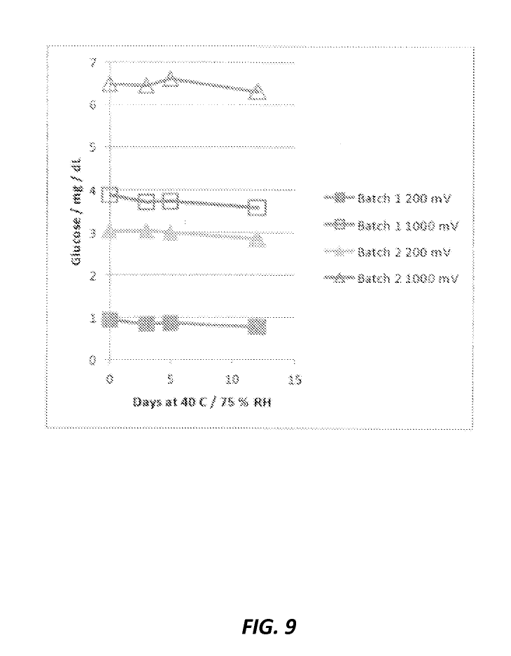

As an example, the polarization parameters for the exemplary test strip batches, Batch 1 and Batch 2, are illustrated with reference to FIG. 8. In this example, as illustrated by FIG. 9, the high potential current (I₂) is measured at 1000 mV and the low potential current (I₁) is measured at 200 mV, both currents being measured approximately five (5) seconds after the application of the test potential. This time period is exemplary and can be varied provided the same time period is used in each current measurement. As graphically illustrated by FIG. 8, the polarization parameters for each batch 1 and 2 commonly decrease with time, indicating a decrease in the polarization of the test strip electrodes.

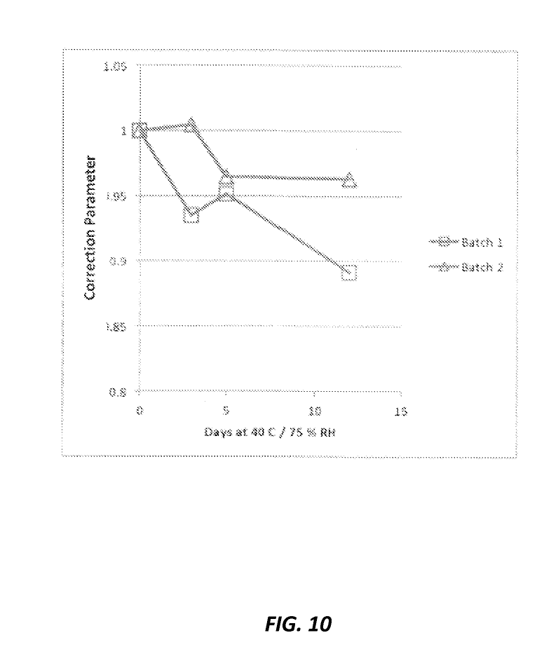

A correction factor is calculated as a ratio of the initial polarization parameter and the testing polarization parameter. This calculation is shown below with regard to Equation 2:

$$Corr = \frac{{PP}_{i}}{{PP}_{t}} , \qquad ( Equation 2 )$$

wherein Corr=Correction parameter, PPᵢ=initial polarization parameter, and PPₜ=testing polarization parameter. As an example, the correction parameters for Batches 1 and 2 are comparatively illustrated by FIG. 10.

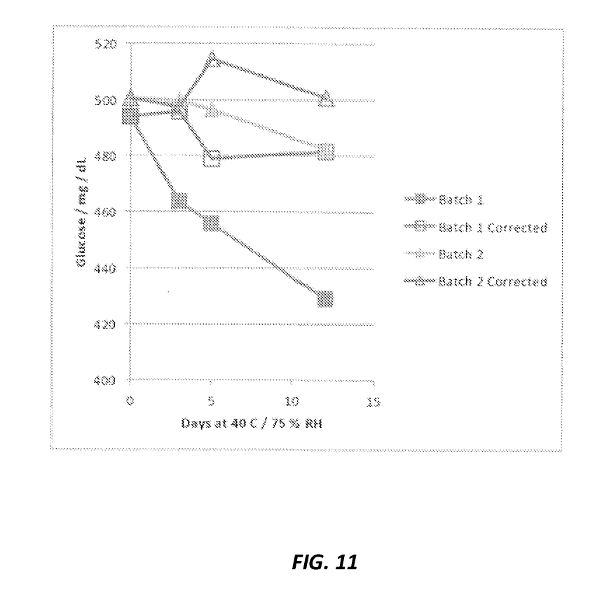

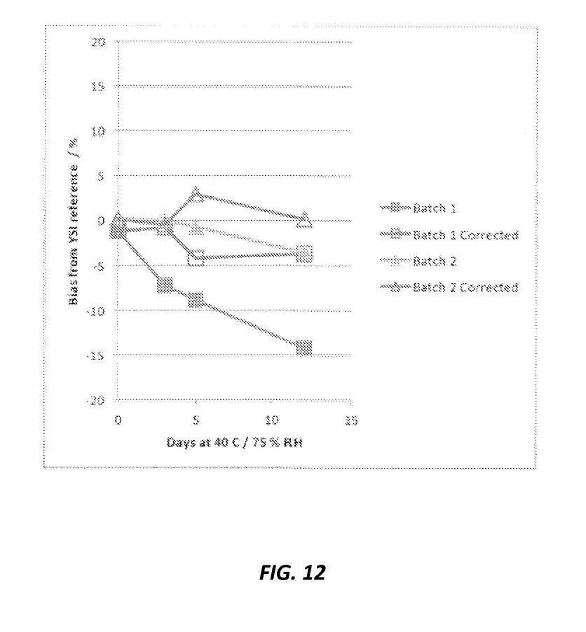

This correction parameter can be applied to a measured analyte concentration in order to produce a corrected analyte concentration that compensates for physical changes, such as depolarization, that the test strip 100 experiences over time. The corrected analyte measurement is calculated as shown by following Equation 3:

$${A}_{C} = \frac{{A}_{M}}{Corr} , \qquad ( Equation 3 )$$

wherein A_{C}=corrected analyte measurement, A_{M}=analyte meaasurement, and Corr=correction parameter. As an example, FIGS. 11-12 illustrate the corrected glucose measurements for Batches 1 and 2. FIG. 11 shows a comparison of the uncorrected glucose measurements and the corrected glucose measurements. In this example, the corrected glucose measurements fall within a range of 480-520 mg/dL. FIG. 12 illustrates the corresponding biases to a Yellow Springs Instrument (YSI) reference. In this example, the bias is held within ±5% with the correction.

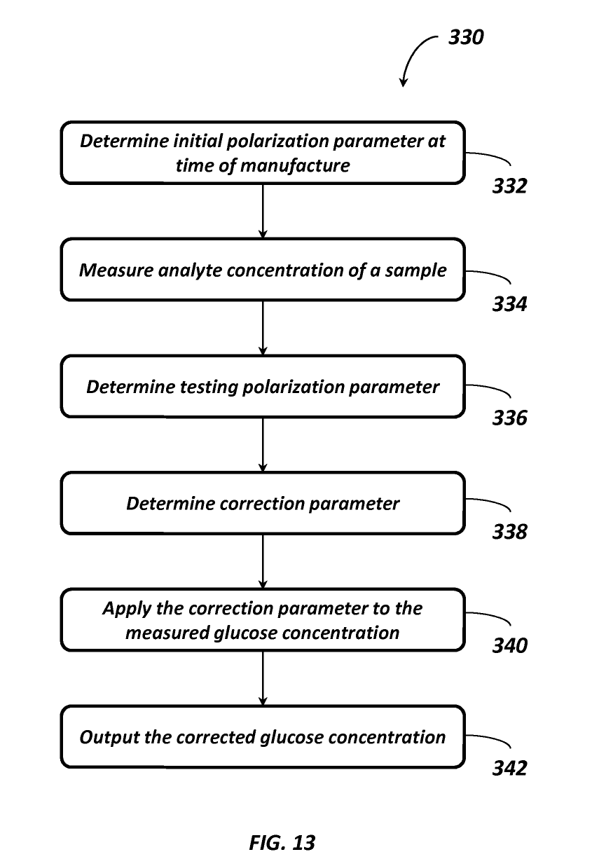

In light of the foregoing example and as illustrated by FIG. 13, a method 330 for correcting (or calibrating) a test strip 100 to account for time-based polarization effects begins at block 332 by determining an initial polarization parameter at the time the test strip 100 is manufactured. As discussed above, the initial polarization parameter is determined by applying a first and second test potential between the electrodes of the test strip, measuring the first and second current (I₁ and I₂) produced in response to the potentials after a predetermined time period, and determining the initial polarization parameter as a ratio between the first and second current (I₁ and I₂). The initial polarization parameter can be determined using Equation 1 above.

At block 334, the analyte concentration of a sample applied to a test strip is measured. The analyte concentration can be measured as described above in regard to FIG. 4. In particular, a potential can be applied to the electrodes of the test strip and a current output by the electrodes in response to the potential measured. The analyte concentration is determined based on the output current. In an embodiment, the sample is blood and the analyte is glucose.

At block 336, the testing polarization parameter is determined. This testing polarization parameter can be determined using the method employed to determine the initial polarization parameter, using Equation 1. The initial polarization parameter is measured at the time the analyte concentration is measured. The initial polarization parameter can be measured during the analyte concentration measurement or directly before or after the analyte concentration measurement.

At block 338, the correction parameter is determined. As discussed above, the correction parameter is calculated as a ratio between the initial polarization parameter and the testing polarization parameter. In particular, the correction parameter is calculated using Equation 2 above. At block 342, the correction parameter is applied to the measured glucose concentration, as discussed above with Equation 3, to produce a corrected glucose concentration. At block 342, the corrected glucose concentration is output to a user, such as on the display of a test meter 200.

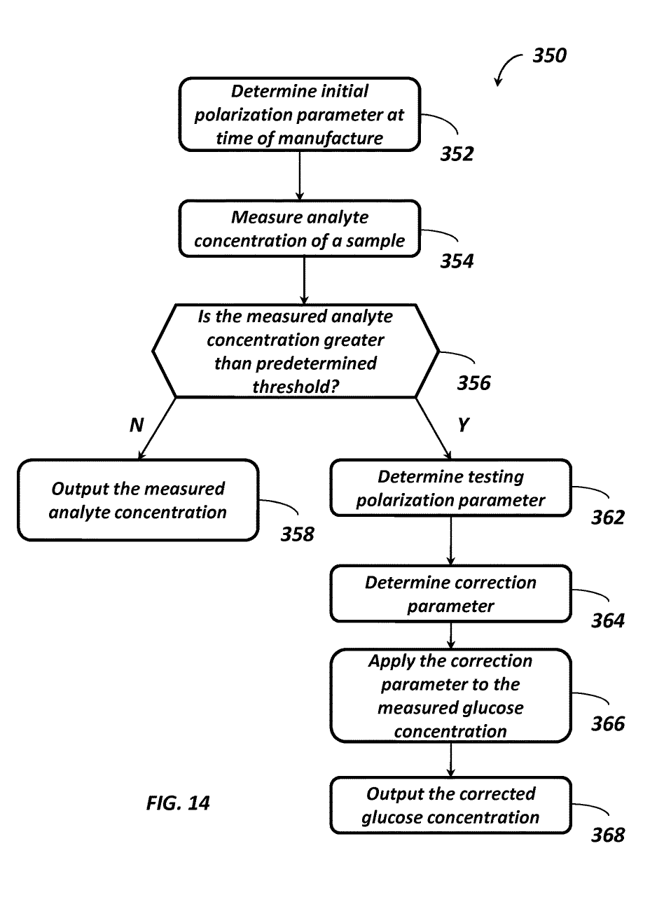

As illustrated by FIG. 14, another method 350 of calibrating (or correcting) a test strip 100 begins at block 352 by determining the initial polarization parameter at the time of manufacture. This initial polarization parameter can be determined following application of first and second potentials between the electrodes, measuring respective currents following a time period after application of the potentials and then utilizing Equation 1. At block 354, the analyte concentration of a sample is measured following application of a potential to the electrodes of the test strip and measuring the current output by the electrodes in response to the potential measured.

At block 356, a processor of a test meter 200 determines if the measured analyte concentration is greater than a stored predetermined threshold. At high analyte concentrations, the effects of the change in physical characteristics (depolarization) of the test strip electrodes are seen while at low analyte concentrations, the effects are minimal. Thus, low analyte concentrations are not corrected due to the risk of over-correcting the concentration. The predetermined threshold can be selected based on the design of the test strip. In an embodiment, the predetermined threshold is at least 200 mg/dL, such as at least 300 mg/dL. If the measured analyte concentration is not greater than the predetermined threshold, the measured analyte concentration is output to a user at block 358.

If the measured analyte concentration is greater than the predetermined threshold, at block 362, the testing polarization parameter is determined, using Equation 1, and, at block 364, the correction parameter is determined as a ratio between the initial polarization parameter and the testing polarization parameter, as shown in Equation 2. At block 366, the correction parameter is applied to the measured glucose concentration, as shown in Equation 3 above, and, at block 368, the corrected glucose concentration is output to the user.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “circuitry,” “module,” ‘subsystem” and/or “system.” Furthermore, aspects of the present invention may take the form of a computer program product embodied in one or more computer readable medium(s) having computer readable program code embodied thereon.

In the aforementioned aspects of the disclosure, the steps of determining, estimating, calculating, computing, deriving and/or utilizing (possibly in conjunction with an equation) may be performed by an electronic circuit or a processor. These steps may also be implemented as executable instructions stored on a computer readable medium; the instructions, when executed by a computer may perform the steps of any one of the aforementioned methods.

In additional aspects of the disclosure, there are computer readable media, each medium comprising executable instructions, which, when executed by a computer, perform the steps of any one of the aforementioned methods.

In additional aspects of the disclosure, there are devices, such as test meters or analyte testing devices, each device or meter comprising an electronic circuit or processor configured to perform the steps of any one of the aforementioned methods.

### PARTS LIST FOR FIGS. 1-14

3 distal portion, test strip
4 proximal portion, test strip
5 substrate, planar
7 reference electrode track
8 first working electrode track
9 second working electrode track
10 reference electrode
11 reference contact pad
12 first working electrode
13 first contact pad
14 second working electrode
15 second contact pad
16 insulation layer
17 strip detection bar
22a reagent layer
22b reagent layer
24 first adhesive pad
26 second adhesive pad
28 third adhesive pad
32 distal hydrophilic portion
50 first conductive layer
60 adhesive layer
70 hydrophilic tape layer
80 top layer
92 sample receiving chamber
94 cover
100 test strip
200 test meter
201 housing
204 display
206 first user interface input
208 first marking
210 user interface input
212 second marking
214 user interface input
216 third marking
218 data port
220 strip port connector
300 processor
302 memory
304 ASIC
306 analog interface
308 core
310 ROM
312 RAM
314 I/O ports
316 A/D converter
318 clock
320 display driver
330 method
332-342 method blocks
350 method
352-368 method blocks
402 current transient
412 current time I_{g}

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A method for determining an analyte concentration of a sample fluid applied to a test strip, the test strip comprising at least two electrodes in spaced relation and defining a reaction chamber, the method comprising:
determining an initial polarization parameter of the test strip at a time of test strip manufacture;
determining a testing polarization parameter of the test strip at a time of testing;
determining a correction parameter of the test strip based on the initial polarization parameter and the testing polarization parameter;
measuring an initial analyte concentration; and
applying the correction parameter to the initial analyte concentration to produce a corrected analyte concentration.

2. The method of claim 1, wherein the at least two electrodes comprise carbon screened electrodes to which an electrical potential can be applied in order to measure an analyte concentration.

3. The method of claim 1, in which measuring the initial analyte concentration comprises:
applying an electrical test potential between the at least two electrodes;
measuring a resulting current output in response to the applied electrical test potential; and
determining the initial analyte concentration based on the current output.

4. The method of claim 1, wherein a polarization parameter is determined by applying a first potential between the at least two electrodes, measuring a resulting first current I₁ at the first potential, applying a second potential between the at least two electrodes, measuring a second resulting current I₂ at the second potential, and determining the polarization parameter as a ratio between the first current I₁ and the second current I₂.

5. The method of claim 4, wherein the polarization parameter is calculated as:
$$PP = \frac{{I}_{1}}{{I}_{2}} ,$$
wherein PP=polarization parameter, I₁=current measured at the first potential, and I₂=current measured at the second potential.

6. The method of claim 5, wherein the first potential is lower than the second potential.

7. The method of claim 1, wherein the correction parameter is based on a ratio of the initial polarization parameter and the testing polarization parameter.

8. The method of claim 7, wherein the correction parameter is calculated as:
$$Corr = \frac{{PP}_{i}}{{PP}_{t}} ,$$
wherein Corr=Correction parameter, PPᵢ=initial polarization parameter, and PPₜ=testing polarization parameter.

9. The method of claim 1, wherein the corrected analyte measurement is calculated as:
$${A}_{C} = \frac{{A}_{M}}{Corr} ,$$
wherein A_{C}=corrected analyte measurement, A_{M}=analyte meaasurement, and Corr=correction parameter.

10. The method of claim 1, further comprising applying the correction parameter to the initial analyte measurement only when the analyte concentration exceeds a predetermined threshold.

11. The method of claim 10, wherein the predetermined threshold is 200 mg/dL.

12. The method of claim 10, wherein the predetermined threshold is 300 mg/dL.

13. The method of claim 1, wherein the step of determining a testing polarization parameter is performed during analyte measurement.

14. The method of claim 1, wherein the sample fluid comprises blood and the analyte comprises glucose.

15. A method for calibrating a test strip comprising at least two electrodes spaced apart as part of a reaction chamber, the method comprising:
determining an initial polarization parameter of the test strip at a time of test strip manufacture;
determining a testing polarization parameter of the test strip at a time of testing; and
determining a correction parameter based on the initial polarization parameter and the testing polarization parameter, the correction parameter comprising a ratio between the initial polarization parameter and the testing polarization parameter, and
wherein the correction parameter is determined in order to calibrate the test strip.

16. The method of claim 15, wherein the at least two electrodes comprise carbon electrodes to which an electrical potential can be applied in order to measure an analyte concentration.

17. The method of claim 16, in which the electrodes are applied by a carbon screen printing process.

18. The method of claim 15, wherein a polarization parameter is determined by applying a first potential between the at least two electrodes, measuring a resulting first current I₁ at the first potential, applying a second potential between the at least two electrodes, measuring a second resulting current I₂ at the second potential, and determining the polarization parameter as a ratio between I₁ and I₂.

19. The method of claim 18, wherein the polarization parameter is calculated as:
$$PP = \frac{{I}_{1}}{{I}_{2}} ,$$
wherein PP=polarization parameter, I₁=current measured at the first potential, and I₂=current measured at the second potential.

20. The method of claim 18, wherein the first potential is lower than the second potential.

21. The method of claim 15, wherein the correction parameter is based on a ratio of the initial polarization parameter and the testing polarization parameter.

22. The method of claim 21, wherein the correction parameter is calculated as:
$$Corr = \frac{{PP}_{i}}{{PP}_{t}} ,$$
wherein Corr=Correction parameter, PPᵢ=initial polarization parameter, and PPₜ=testing polarization parameter.

23. The method of claim 15, further comprising applying the correction parameter to a measured analyte concentration to determine a corrected glucose measurement.

24. The method of claim 23, wherein the measured analyte concentration is measured by:
applying an electrical test potential to the at least two electrodes;
measuring a resulting current output of the at least two electrodes in response to the applied electrical test potential; and
determining the measured analyte concentration based on the current output.

25. An analyte measurement system, comprising:
a test strip, comprising:
at least two spaced apart electrodes defining a reaction chamber,
the at least two electrodes comprising carbon electrodes to which an electrical potential can be applied in order to measure an analyte concentration; and
an test meter, comprising:
a strip port having connectors configured to couple to the at least two electrodes of the test strip; and
a processor configured to:
determine a testing polarization parameter of the test strip at a time of testing;
access a stored initial polarization parameter of the test strip, the initial polarization parameter determined at a time of test strip manufacture;
determine a correction parameter of the test strip based on the initial polarization parameter and the testing polarization parameter;
measure an analyte concentration; and
apply the correction parameter to the measured analyte concentration to produce a corrected analyte concentration.

26. The method of claim 25, in which the electrodes are formed using a carbon screen printing process.

27. The method of claim 25, measuring the initial analyte concentration comprising:
applying an electrical test potential between the at least two electrodes;
measuring a resulting current output of the at least two electrodes in response to the applied electrical test potential; and
determining the initial analyte concentration based on the current output.

28. The method of claim 25, wherein a polarization parameter is determined by applying a first potential between the at least two electrodes, measuring a resulting first current I₁ at the first potential, applying a second potential between the at least two electrodes, measuring a second resulting current I₂ at the second potential, and determining the polarization parameter as a ratio between I₁ and I₂.

29. The method of claim 28, wherein the polarization parameter is calculated as:
$$PP = \frac{{I}_{1}}{{I}_{2}} ,$$
wherein PP=polarization parameter, I₁=current measured at the first potential, and I₂=current measured at the second potential.

30. The method of claim 29, wherein the first potential is lower than the second potential.

31. The method of claim 25, wherein the correction parameter is based on a ratio of the initial polarization parameter and the testing polarization parameter.

32. The method of claim 31, wherein the correction parameter is calculated as:
$$Corr = \frac{{PP}_{i}}{{PP}_{t}} ,$$
wherein Corr=Correction parameter, PPᵢ=initial polarization parameter, and PPₜ=testing polarization parameter.

33. The method of claim 25, wherein the corrected analyte measurement is calculated as:
$${A}_{C} = \frac{{A}_{M}}{Corr} ,$$
wherein A_{C}=corrected analyte measurement, A_{M}=analyte meaasurement, and Corr=correction parameter.

34. The method of claim 25, further comprising applying the correction parameter to the initial analyte measurement only when the analyte concentration exceeds a predetermined threshold.

35. The method of claim 34, wherein the predetermined threshold is 200 mg/dL.

36. The method of claim 34, wherein the predetermined threshold is 300 mg/dL.

37. The method of claim 25, wherein the step of determining a testing polarization parameter is performed during analyte measurement.

38. The method of claim 25, wherein the analyte comprises glucose.
